(19) United States
(12) Patent Application Publication
(10) Pub. No.: US 2026/0299105 A1
(43) Pub. Date: Oct. 1, 2026

(54) MULTI-MILLISECOND RANGING IN ULTRA-WIDEBAND SYSTEMS

(71) Applicant: Qorvo US, Inc., Greensboro, NC (US)

(72) Inventors: Michael McLaughlin, Dublin (IE); Jaroslaw Niewczas, Jozefow (PL); Billy Verso, Maynooth (IE); Carl Murray, Dublin (IE)

(21) Appl. No.: 19/489,365

(22) PCT Filed: Jun. 7, 2024
(86) PCT No.: PCT/US2024/033054

§ 371 Date: Dec. 2, 2025

Related U.S. Application Data
(60) Provisional application No. 63/512,372, filed on Jul. 7, 2023.
(60) Provisional application No. 63/555,742, filed on Feb. 20, 2024.

(51) Int. Cl. G01S 13/02

(52) U.S. Cl. CPC G01S 13/0209

(57) ABSTRACT

A method of receiving a plurality of multi-millisecond (MMS) fragments in an ultra-wideband (UWB) device is disclosed. The method includes processing each of the plurality of MMS fragments based on an initial range of CFO values and a coarse timing estimate. For each MMS fragment, the processing comprises performing coherent fragment accumulation using parallel processing for a plurality of carrier slice CFO values within the initial range, resulting in a number of fragment-accumulators; and applying parallel fragment-dependent timing drift correction to each corresponding fragment-accumulator, yielding a plurality of timing-corrected fragment-accumulators, one for each of a plurality of timing slice CFO hypotheses. The method may further include, for each of the timing slice CFO hypotheses, combining the plurality of timing-corrected fragment-accumulators to yield a plurality of combined final accumulators. The method may further include identifying one of the plurality of combined final accumulators as a selected final accumulator.

### CROSS-REFERENCE TO RELATED APPLICATIONS

The present application claims the benefit of U.S. Provisional App. No. 63/512,372, entitled “Multi-Millisecond Ranging in Ultra-Wideband” and filed on Jul. 7, 2023, and U.S. Provisional App. No. 63/555,742, entitled “Multi-Millisecond Ranging in Ultra-Wideband Systems” and filed on Feb. 20, 2024, both of which are incorporated by reference herein in their entireties.

### TECHNICAL FIELD

The present disclosure relates generally to ranging in ultra-wideband systems, and, more specifically, to systems, methods, and devices for ranging in ultra-wideband systems that use multi-millisecond transmissions.

### BACKGROUND

Ranging of ultra-wideband (UWB) devices is limited by the regulatory requirements on average transmit power (such as transmit power per unit of time, such as a millisecond (ms)). For example, due to the duration of transmission of conventional UWB transmissions, such as High Rate Pulse Repetition Frequency (HRP) UWB mode transmissions, each transmission may occur at a relatively low power in order to comply with average power requirements, making it difficult to perform ranging with sufficient accuracy at increasing distances/ranges.

FIG. 1 illustrates known packet configurations for HRP UWB, according to some aspects of the present disclosure. The fields of the packet configurations are illustrated, with the synchronization field denoted by SYNC, the state-of-frame delimiter denoted by SFD, the PHY (physical layer) header represented by PHR, the physical layer payload represented by PHY Payload, and the Scrambled Timestamp Sequence field represented by STS. These packet configurations are transmitted with a relatively low power, such as to comply with average power requirements, making it difficult to perform ranging with sufficient accuracy at increasing distances/ranges.

Thus, there remains a need for techniques that work at increased ranges, while still complying with regulatory requirements on average transmit power.

### SUMMARY

Embodiments of the present disclosure include systems, devices, and methods of communication multi-millisecond (MMS) fragments.

In an exemplary aspect, method of receiving a plurality of MMS fragments in a UWB device is disclosed. The method includes establishing an initial range of carrier frequency offset (CFO) values, and establishing a coarse timing estimate of a start of the plurality of MMS fragments. The method may further include processing each of the plurality of MMS fragments based on the initial range of CFO values and the coarse timing estimate. For each MMS fragment, the processing comprises performing coherent fragment accumulation using parallel processing for a plurality of carrier slice CFO values within the initial range, resulting in a number of fragment-accumulators; and applying parallel fragment-dependent timing drift correction to each corresponding fragment-accumulator, yielding a plurality of timing-corrected fragment-accumulators, one for each of a plurality of timing slice CFO hypotheses. The method may further include after processing the plurality of MMS fragments, for each of the timing slice CFO hypotheses, combining the plurality of timing-corrected fragment-accumulators to yield a plurality of combined final accumulators. The method may further include identifying one of the plurality of combined final accumulators as a selected final accumulator based on at least one criteria.

In another exemplary aspect, a wireless apparatus is disclosed. The wireless apparatus includes a radio frequency circuit configured to downconvert a plurality of UWB MMS fragments to generate a plurality of received MMS fragments. The wireless apparatus may further include a plurality of accumulators configured to process each of the plurality of received MMS fragments using a plurality of carrier slice CFO values, wherein the accumulators and carrier slice CFO values are in one-to-one correspondence, resulting in a number of fragment-accumulation signals per fragment. The wireless apparatus may further include a plurality of banks of timing processing units, wherein each of the plurality of accumulators is coupled to a corresponding bank of timing processing units, and wherein, for each fragment, the plurality of banks of timing processing units apply parallel fragment-dependent timing offset correction to each corresponding fragment-accumulation signal, yielding timing-corrected fragment-accumulators, one for each of a plurality of timing slice CFO hypotheses. The wireless apparatus may further include a processor configured to combine the timing-corrected fragment-accumulators for each of the plurality of timing slice CFO hypotheses over the plurality of MMS fragments to yield a plurality of combined final accumulators; and identify one of the plurality of combined final accumulators as a selected final accumulator based on at least one criteria.

In another exemplary aspect, a wireless communication device is disclosed. The wireless communication device may include a memory configured to store an initial range of CFO values and a coarse timing estimate of a start of a plurality of MMS fragments. The wireless communication device may further include a UWB receiver configured to receive the plurality of MMS fragments, wherein for each MMS fragment. The receiving may include performing coherent fragment accumulation using parallel processing for a plurality of carrier slice CFO values within the initial range, resulting in a number of fragment-accumulators; and applying parallel fragment-dependent timing drift correction to each corresponding fragment-accumulator, yielding a plurality of timing-corrected fragment-accumulators, one for each of a plurality of timing slice CFO hypotheses. The wireless communication device may further include a processor. The processor may be configured to after receiving the plurality of MMS fragments, for each of the plurality of timing slice CFO hypotheses, combine the timing-corrected fragment-accumulators yielding a plurality of combined final accumulators; and identify one of the plurality of combined final accumulators as a selected final accumulator based on at least one criteria.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 illustrates known packet configurations for HRP UWB, according to some aspects of the present disclosure.

FIG. 2 illustrates an exemplary transmission frame that may be used for ranging, according to some aspects of the present disclosure.

FIG. 3 illustrates an exemplary set of transmissions that may be used for ranging, according to some aspects of the present disclosure.

FIG. 4 illustrates an exemplary method of processing and combining MMS transmissions, according to some aspects of the present disclosure.

FIG. 5 illustrates loss of peak amplitude due to mismatched CFO (channel 5), according to some aspects of the present disclosure.

FIG. 6 illustrates the performance of various hybrid coherent/non-coherent accumulation schemes against a coherent scheme, according to some aspects of the present disclosure.

FIG. 7 illustrates an accumulator for processing a single carrier slice, according to some aspects of the present disclosure.

FIG. 8 illustrates a timing processing unit for processing a single timing slice, according to some aspects of the present disclosure.

FIG. 9 illustrates a mobile device for processing of multiple timing and carrier slices, according to some aspects of the present disclosure.

FIG. 10 illustrates example carrier slices (bold) and timing slices, according to some aspects of the present disclosure.

FIG. 11 presents an example of final combined accumulators, according to some aspects of the present disclosure.

FIG. 12 is a diagram illustrating a two-way ranging-based localization system, according to aspects of the present disclosure.

FIG. 13 illustrates an exemplary method of processing and combining MMS transmissions, according to some aspects of the present disclosure.

FIG. 14 illustrates an example of a communication device, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Exemplary embodiments of methods, systems, and devices are presented herein for overcoming link budget challenges in conventional UWB communications. The techniques disclosed herein use multi-millisecond (MMS) transmissions, thereby increasing the transmission power budget. While this can potentially increase the overall signal signal-to-noise ratio, combining energy collected over multiple milliseconds poses new challenges. The received signal level (per symbol) at these increased ranges may be many decibels (dBs) lower than the typical UWB receiver requirements, making the signal difficult to detect and making carrier tracking difficult. Without carrier tracking, the receiver could start correlation and accumulation blindly.

In some embodiments, ranging may be performed in stages. According to some aspects, coarse CFO estimation (carrier frequency offset) occurs by selecting a range of CFOs (such as a reduced range relative to a default +/−40 parts-per-million (ppm) range). Next, coherent fragment accumulation is performed using parallel (or serial) processing for a range of CFO values, called “carrier recovery slices” or simply “carrier slices”, resulting in a number of fragment-accumulators, per each MMS fragment. In each MMS fragment, one fragment accumulator is produced for each carrier slice. The total number of fragment-accumulators could be equal to the number of MMS fragments multiplied by the number of carrier slices. Next, parallel processing is applied to the fragment-accumulators to apply timing offset correction for a range of “timing recovery slices”, or simply “timing slices”, resulting in a number of timing-corrected fragment-accumulators. The timing offset correction depends on the CFO, so every “timing slice” corresponds to a specific CFO value. Note that the set of CFO values used in the carrier slices may be different that the set of CFO values used for the timing slices. The CFO range covered in both cases is generally the same, but there may be different CFO step size applied to carrier and timing sets of CFO values. According to some aspects, in a final step, the method includes performing parallel summation of fragments for each timing slice and selecting a final accumulator according to one or more criteria. For example, the final accumulator may be selected that has the largest correlation peak, provided the peak exceeds a required threshold.

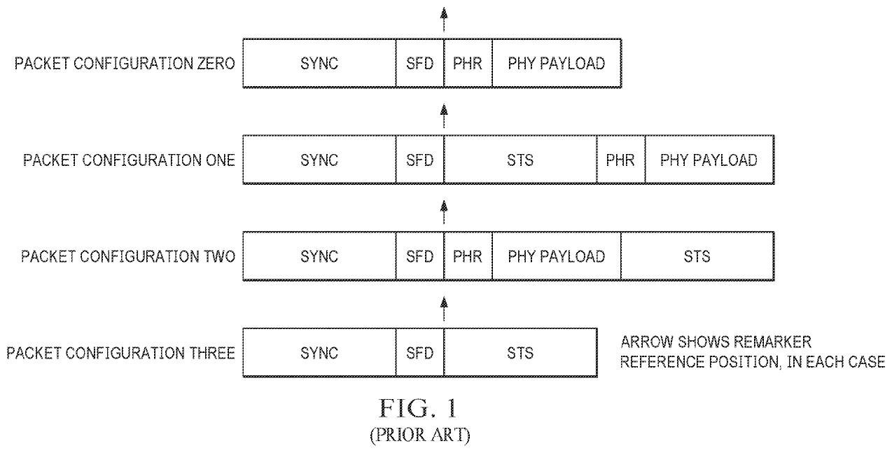

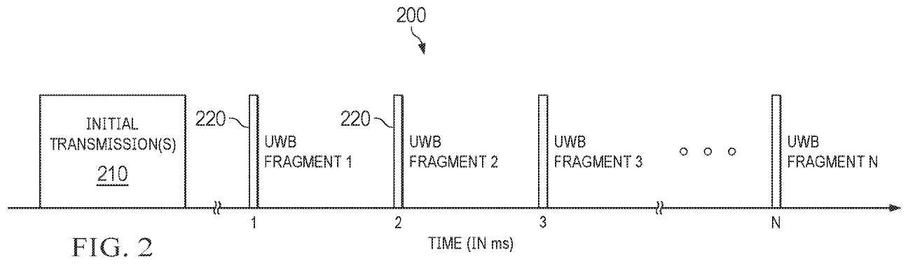

FIG. 2 illustrates an exemplary transmission frame 200 that may be used for ranging, according to some aspects of the present disclosure. In this embodiment, the frame 200 includes one or more initial transmissions 210 followed by MMS fragments 220. MMS transmissions (e.g., an MMS packet) may include a series of fragments 220, transmitted at most one per millisecond. The initial transmissions 210 may include a transmission, referred to as a narrowband (NB) transmission, using Bluetooth, Wi-Fi, or another PHY. Initial estimates of timing and/or CFO may be derived from NB transmissions. These initial estimates of timing may be referred to as coarse timing estimate, and initial estimates of CFO may be referred to as coarse CFO estimates. In MMS methods, it may be beneficial to have a short fragment (for example lasting 8 microseconds (μs) or 32 μs) per millisecond transmitted at high TX power, rather than continuous low-TX-power transmission spreading over multiple milli-seconds, such as the packets illustrated in FIG. 1. This relaxes CFO estimation accuracy requirements in the receiver, since with short fragments each fragment can be accumulated separately.

This disclosure recognizes that the shorter the fragment the greater the CFO offset can be before coherent accumulation is overly impaired. For example, fragments of a length (duration) 8 μs or 32 μs, may be preferable to fragments that are 64 μs in length. However, these multiple fragments may need to be combined into one final single accumulator. An MMS packet may include these MMS fragments. The MMS fragments 220 may be used in blind parallel processing for a range of CFOs, and the slice closest to the true CFO will be received with performance nearly equal to the receiver being synchronized. Thus, in this manner, the MMS fragments 220 may be used for ranging applications involving UWB wireless devices.

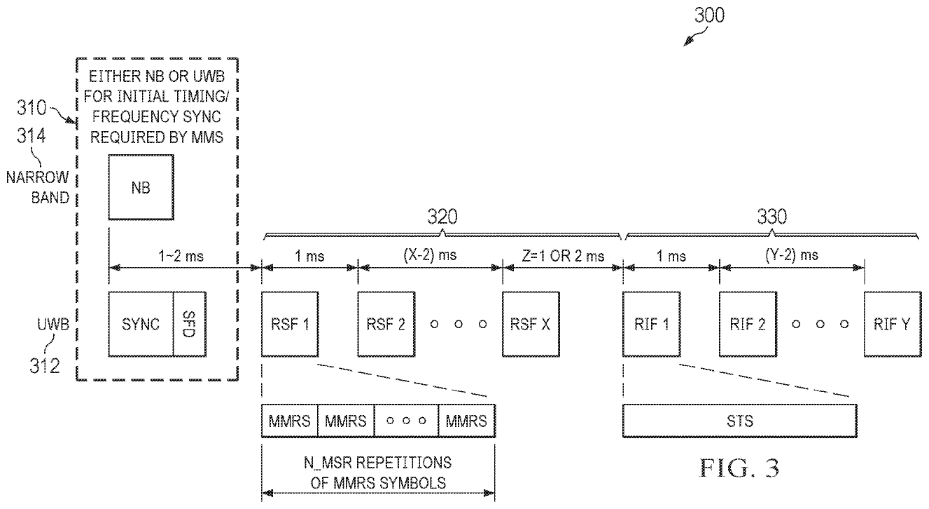

FIG. 3 illustrates an exemplary set of transmissions 300 that may be used for ranging, according to some aspects of the present disclosure. According to some aspects, the transmissions 300 include one or more initial transmissions 310 followed by MMS fragments, categorized as Ranging Sequence Fragments (RSFs) 320, followed by Ranging Integrity Fragments (RIFs) 300. As shown, each RSF 320 may include a number (N_MSR) of repetitions of multi-millisecond ranging sequence (MMRS) symbols, and each RIF 330 may include a Scrambled Timestamp Sequence (STS). Two options for initial transmissions 310 are presented—one or more NB transmissions 314 or one or more UWB transmissions 312. In an embodiment, a fragment (of the RSFs 320 or RIFs) may be transmitted per millisecond (ms). One of the UWB transmissions 312 or NB transmissions 314 may be used for initial (coarse) timing and/or frequency estimation. If the narrow-band assist (NB) is not available and the UWB transmission 312 is too weak to synchronize timing and/or frequency (or 312 may not be present at all), the receiver may take alternative approach. Blind parallel processing of the fragments 320/330 may be used to combine energy over multiple milliseconds, yielding improved link margin. The information gleaned from fragments 320/330 may also be used for ranging applications involving wireless devices.

One problem with using assistance via the NB 314 transmissions (sometimes referred to as NB assistance) may be high power at 6 GHz and/or risk of interference in WiFi channels. This disclosure presents methods and systems that achieve performance similar to 6 GHz NB assistance but without the use of the 6 GHz NB transmissions (e.g., without estimating parameters using 6 GHz NB transmissions).

### Assistance from Another PHY

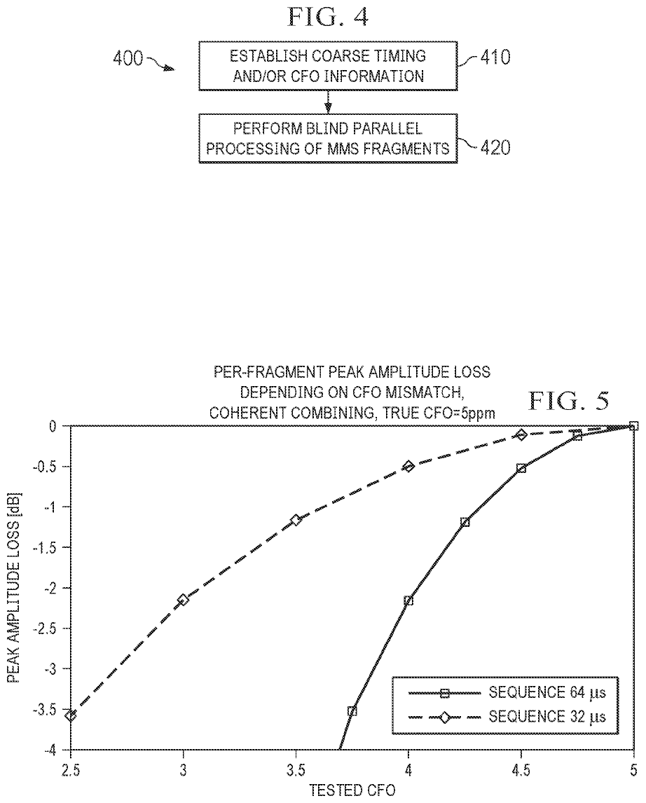

FIG. 4 illustrates an exemplary method 400 for processing and combining MMS transmissions, according to some aspects of the present disclosure. As shown, the method 400 includes establishing coarse timing and/or CFO information 410 (such as estimating this information or communicating this information). Coarse timing and/or CFO information may be communicated using the assistance of another PHY. Coarse timing and/or CFO information can refer to timing and/or CFO information that is generally within a range of uncertainty. For example, the coarse CFO information may be established as a coarse CFO estimate within a range, such as the coarse CFO estimate bounded by an uncertainty range represented in terms of ppm of error. The range may be referred to as including a CFO estimate bounded by an error tolerance, with the error tolerance being expressed in ppm, for example. As a numerical example, the UWB carrier frequency may be 8 GHz, the coarse CFO estimate may be +/−5 ppm, yielding a range of CFO between −40 kHz and +40 kHz.

Next, the method 400 includes the step 420 of performing blind parallel processing of MMS fragments. Blind parallel processing of MMS fragments reduces the range of uncertainty of timing and CFO information as compared to step 410, yielding accurate ranging information. Various techniques for performing the step of 410 are presented below. Techniques for performing step 420 in FIG. 4 are presented in the next sections (e.g., the section entitled “Combining Multiple Fragments”).

There are other PHYs present on typical consumer devices (Bluetooth, WiFi) which have much higher transmission power limit and range, but have more limited ranging capabilities than UWB. Therefore, if such high TX-power PHY was combined with UWB and provided some form of assistance, UWB performance could be much better. The assistance could have several features:
1. Basic exchange of parameters for an UWB session (setup: configuration of packets, type of sequences used, their lengths, device identification, response delays etc.)
2. Timing information: triggering the UWB TX/RX at the exact time, so that the UWB receiver could turn on to collect energy only when the remote transmitter is sending it
3. Coarse CFO information: To allow the UWB receiver to know what range of carrier offsets to expect

One embodiment (a first feature, or Feature 1) involves data exchange and could be provided by any PHY which has sufficient range.

In another embodiment (a second feature, or Feature 2) another PHY may be used to assist in triggering UWB transmission/reception with sufficiently good timing precision. If a UWB symbol length is 1 μs, ideally, the UWB timing trigger accuracy should be better than +/−500 ns, otherwise the system could make a ranging error by 1 μs (300 meters). Accuracy of timing estimation depends on PHY's bandwidth (BW). For a 1 MHz BW PHY (like Bluetooth), timing accuracy in the range of +/−400 ns should be possible.

However, even if the timing trigger was not sufficiently precise and UWB system mis-estimated the distance by full symbol length of lus (300 meters), in most applications is should not matter because practical distances measured will be below 100 meters, such as in indoor non-line-of-sight (NLOS) conditions. For example, a result of 305 meters can be interpreted as 5 meters and a result of −200 meters could be interpreted as +100 meters.

In one embodiment, devices could start ranging process with repetitive (non-secure) MMS fragments such as known Ipatov or CZC sequences. The receiver could start listening earlier than the expected start (for example 4 μs) to make sure no symbol is lost, and the range is calculated modulo 300 meters. Then it could prepare for and execute the second part of MMS exchange, this time with N*300 meter correction included, using possibly encrypted fragments (STS). With this method, the timing accuracy expected from other PHY would be relaxed.

As one alternative, the symbols used could be longer to provide more flexibility in timing uncertainty. In another alternative, STS fragments may be used to resolve the timing ambiguity, since the STS segments may not repeat.

Accurately accounting for the CFO allows for coherent (in-phase) accumulation since the phase change can be taken into account. For coherent accumulation of a single fragment, a required accuracy of CFO estimation depends on the fragment's length. For example, for 32 μs fragments, a required accuracy may be +/−1 ppm, and for 8 μs fragment a required accuracy may be +/−4 ppm. Such precision is achievable by Bluetooth and other PHYS.

However, to execute coherent combining of multiple fragments, much higher CFO accuracy may be required. For eight fragments transmitted over a span of eight milliseconds, the time between the first and the last fragments may be 7 ms, and required CFO accuracy may be in a range of 5 parts-per-billion, which can be very challenging to achieve. Even if such an accurate estimate is possible, crystal oscillator instabilities, phase noise affecting transmitter or receiver and other effect, may introduce random phase changes between fragments. In that case, the fragment combining algorithm would need to combine fragments without phase compensation, for example, non-coherent combining (i.e., adding only absolute values).

### Per-Fragment Accumulation

In some embodiments, per-fragment accumulation is a useful element of MMS ranging. In an embodiment, per-fragment accumulation is executed coherently; otherwise, the performance loss can be unacceptably high. If another PHY can provide an accurate CFO estimate (depending on fragment length), carrier phase compensation and accumulation is straightforward. In an embodiment, both PHYs (UWB and the other PHY) may ensure that their internal carrier generation clocks and symbol generation clocks are phase locked to the same clock source.

If another PHY cannot provide a sufficiently good CFO estimate to the UWB PHY, the UWB receiver can perform multiple parallel accumulation/phase-compensation processing instances, where each process instance will implement a different CFO compensation, thereby performing an example of step 420. For example, using 8 μs MMS fragments, there could be 5 parallel processes performing fixed CFO compensation at −16 ppm, −8 ppm, 0 ppm, 8 ppm, 16 ppm (generally referred to herein as “carrier slices”). Such an approach can be sufficient to cover a CFO uncertainty range between −20 ppm and +20 ppm in this example. More generally, carrier slices can be selected to cover other ranges, such as +/−10 ppm, +/−30 ppm, etc.

In addition to performing parallel searches at various CFO offsets the receiver could split the search up and spend some time searching for a signal at one range of CFO offsets and then, later on, do another search with a different range of CFO offsets. For example if it knows that the signal is being sent every 2 seconds and it knows that the possible range of CFOs could be −100 ppm to +100 ppm but it only has enough resources, (memory and/or processing power) to do a search in a 50 ppm range of CFOs, it could spend 2 seconds searching in the region −100 ppm to −50 ppm then another 2 seconds in the region −50 pmm to 0 ppm etc until it has searched the full range of expected CFOs. In this way it would find the signal within 8 seconds. (Note it could spend a little longer than 2 seconds on each sub-search to guarantee that it covers the time that the message is sent). If some CFO regions are more likely than others it could start with those regions before searching the less likely regions in order to minimize the expected time to find the signal. For example if it had recently communicated with the device it is now looking for and it found it at a particular CFO it could start with CFOs near that previously successful value in the expectation that, unless there had been a large temperature change in the meantime, the CFO would be quite close to the previous value.

As part of the processing, in addition to the carrier slices, there may also be timing slices. While carrier slices use different phase change compensations, timing slices may use different timing drift compensations. The details are provided below in this disclosure.

With 32 μs fragments, it may be desirable for the carrier slices to be placed in 2 ppm steps, for the loss to be limited to ~0.5 dB (channel 5, at 6.5 GHz) or ~0.8 dB (channel 9 at 8 GHz).

According to some aspects, FIG. 5 illustrates loss of peak amplitude due to mismatched CFO (for channel 5).

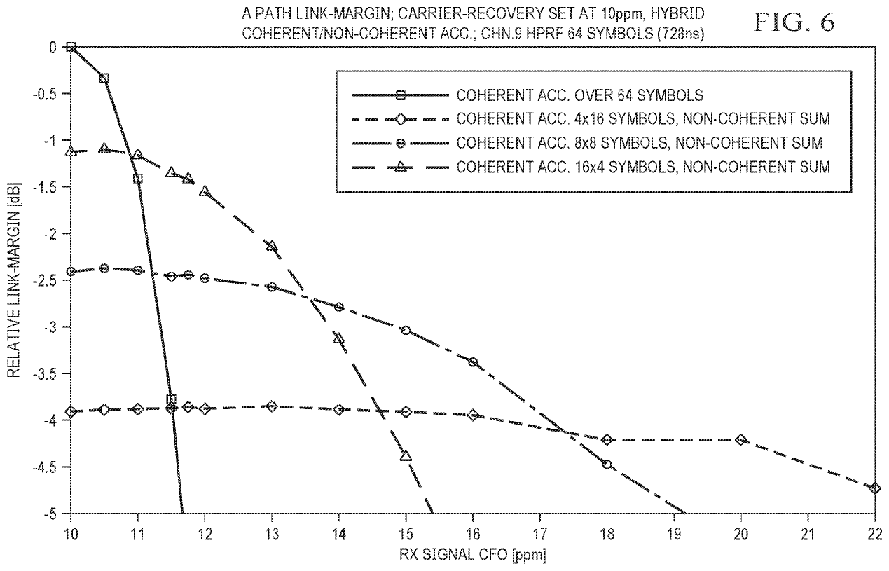

Certain hybrid coherent/non-coherent approaches can also be used. For example, a fragment could be split into N shorter parts, with each part being accumulated coherently and then these separately accumulated parts can be added together non-coherently. That approach limits the maximum phase change that can occur during coherent accumulation, increases tolerance to CFO mismatch, and could allow for an increase in step size between carrier slices (i.e., reducing the number of processing slices needed). However, it also has a cost of some lost performance (see FIG. 6). According to some aspects, FIG. 6 illustrates the performance of various hybrid coherent/non-coherent accumulation schemes against a coherent scheme.

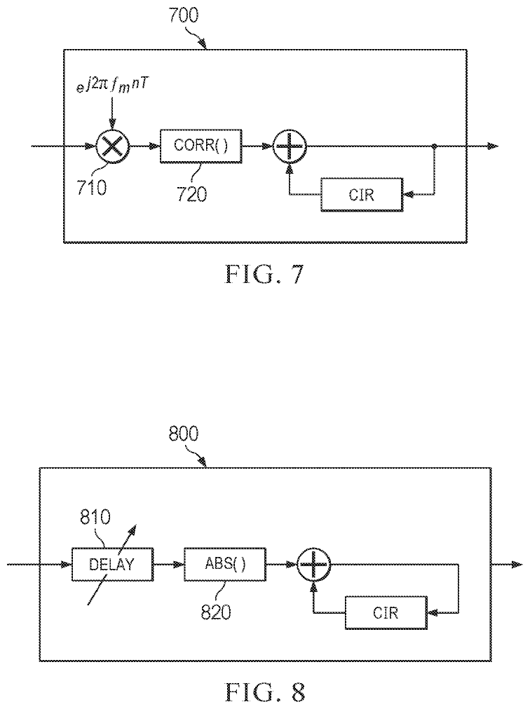

FIG. 7 illustrates an accumulator 700 for processing a single carrier slice, with CFO estimated as fₘ, according to some aspects of the disclosure. As shown, the accumulator 700 includes a mixer 710 and a correlator 720. The accumulator 700 also includes a feedback loop with adder for iteratively adding data from the correlator 720 to form a CIR (channel impulse response) estimate. The mixer 710 mixes the incoming signal (after downconverted from its carrier frequency, not shown) with a sinusoidal signal at frequency fₘ, which represents an estimate of CFO. The accumulator 700 may be configured to process an MMS fragment. The accumulator 700 may be implemented in a receiver. As shown below, using a bank of accumulators, such as accumulator 700, each with different CFO estimates, allows for parallel processing to receive MMS fragments at relatively low power.

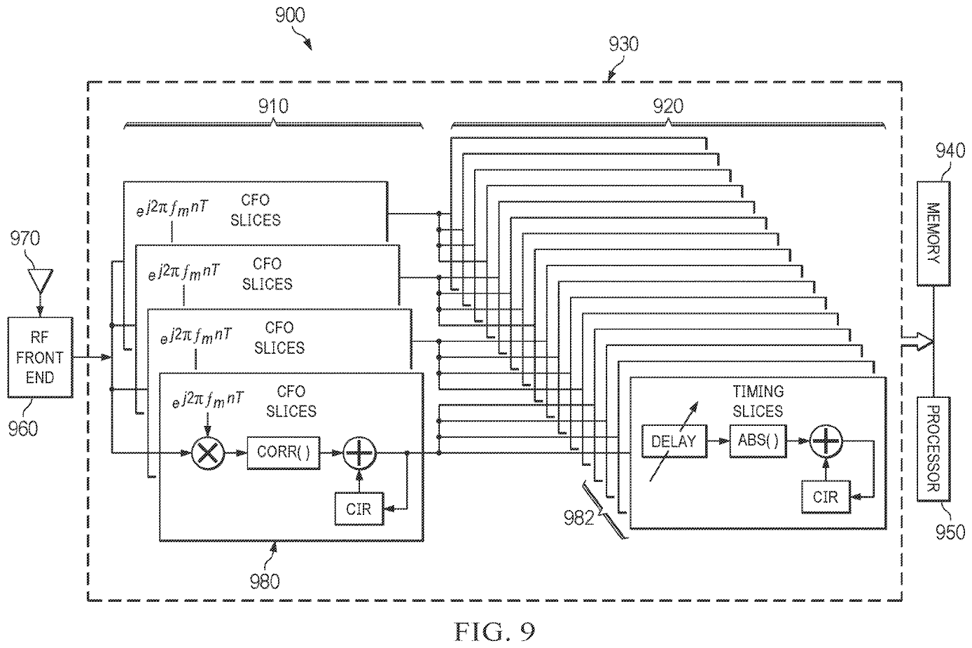

FIG. 8 illustrates a timing processing unit 800 for processing a single timing slice, according to some aspects of the present disclosure. The timing processing unit 800 may also be referred to as a timing slice processing unit. As shown, the timing processing unit 800 may include a variable delay 810 followed by a block that computes absolute value 820, followed by a feedback loop for forming the final CIR estimate. The timing processing unit 800 may be configured to process a series of MMS fragments.

FIG. 9 illustrates a mobile device 900 for processing multiple timing and carrier slices, according to some aspects of the present disclosure. As shown, the device 900 includes an antenna 970 and radio frequency front-end circuitry 960, such as conventional filter(s) and a downconverter as is typically used in RF receivers. The device further includes MMS processing circuitry 930. In an embodiment, the MMS processing circuitry 930 includes a bank of accumulators 910, each connected to a corresponding bank of timing processing units 920 as shown. There may be a temporary memory buffer located between 910 and 920, for storing fragment-accumulators, in which case block 920 processes all data after the final MMS fragment. In other words, each accumulator is connected to a corresponding bank of timing processing units, such that there are a plurality of banks of timing processing units. The bank of accumulators 910 includes a plurality of accumulators, and each bank of timing processing units includes a plurality of timing processing units. In an embodiment, each of the accumulators in the bank of accumulators 910 is the same as the accumulator 700 in FIG. 7 for processing a carrier slice. In an embodiment, each of the timing processing units 920 is the same as the timing processing unit 800 in FIG. 8 for processing a timing slice. In this example, there are five accumulators, each testing a different hypothesis for CFO value in parallel using a series of MMS fragments. Each of the accumulators processes a received fragment in parallel with the other accumulators, and the accumulators generate outputs for the MMS fragment, that are then stored. Each accumulator may generate a fragment-accumulation signal per fragment. Moreover, each of the five accumulators is connected to a set of four timing processing units, each testing a different fragment-dependent hypothesis of delay (because the amount of timing drift is dependent on CFO and the amount of time that has passed). Note that timing is typically corrected starting from the second fragment in a series of fragments. An exemplary accumulator 980 is connected to an exemplary bank 982 of four timing processing units, as shown.

The bank of accumulators 910 is run per MMS fragment, producing N CIRs, one for each of the N fragments. The N CIRs are fed into 920, where each of the N CIRs is delayed differently depending on the timing slice and then added to one of the final CIRs (there is one final CIR per timing slice). The CIR at the output of 920 is the final CIR, and the CIR at the output of each accumulator 980 is a fragment CIR.

Outputs from the MMS processing circuitry 930 are fed into a memory 940 and/or a processor 950. The memory 940 may be used to store outputs from the bank of accumulators 910 and/or the bank of timing processing units 920 on a per-fragment basis. In one embodiment, the processor 950 evaluates outputs from the bank of accumulators 910 and/or the bank of timing processing units 920 to determine an estimate of CFO and delay to be used in processing received signals to make ranging determinations.

In the example of the device 900, the output of each accumulator is connected to a bank of four timing processing units. For each fragment, each accumulator in 910 produces outputs that are provided to a corresponding bank of timing processing units. Outputs of each of the bank of timing processing units are saved for each fragment. The delay used for each of the timing processing units is proportional to the CFO value used in the corresponding timing slice and the fragment number.

In various embodiments, functions/operations may be stored as one or more instructions or code in memory 940, such as on a computer-readable storage medium, such as random access memory (RAM), read-only memory (ROM), FLASH, or disc drive, and executed by processor 950. Mobile device 900 may also include software components (e.g., located within memory 940), including, for example, an operating system, device drivers, executable libraries, and/or other executable code, such as one or more application programs. The application programs may include computer programs, stored in memory 940, executed by processor 950 to implement various functions under the control of the operating system. The computer programs may have been pre-packaged with mobile device 900 or may have been downloaded by a user into memory 940 of the mobile device 101.

The device 900 illustrates basic MMS receiver processing, according to some aspects of the disclosure. The RF front end 960 down converts the received signal under the assumption that a certain carrier frequency is used. Due to various factors as discussed herein, the output of a down converter still has a CFO uncertainty. Therefore, inputs to the accumulators in the bank of accumulators 910 have a CFO uncertainty range. To reduce processing complexity, it is beneficial to reduce the CFO uncertainty range in the input signal. There are several methods for reducing the CFO uncertainty, as presented below. The methods implement the step 410 in FIG. 4, for example.

Method 1: According to a first method, UWB CFO can be measured when devices are initially “paired,” for example a smartphone to a tag pairing. Most applications require initial pairing. In the process, devices exchange capabilities and parameters of future UWB exchanges.

Such pairing is typically done at close range and can use regular UWB packets. It is possible to measure and save the UWB CFO observed during the pairing process. Subsequent MMS exchanges between those devices can use the UWB CFO measured previously as the center CFO. If the most recent pairing was done some time ago, over time, the CFO can change (for example due to aging or temperature effects), but that change will be within knowable limits. For example, the aging characteristics of the crystal are often supplied by the manufacturer. The change in frequency with temperature is also usually supplied. With this knowledge, the receivers could use reduced number of carrier (and timing) slices in processing.

If devices have been already paired, they can periodically communicate via UWB or by another method, and update the saved UWB CFO estimate. If the device has some way of knowing its own temperature, the devices can also communicate the current temperature before the UWB portion of the MMS exchange starts.

Method 2: If unknown or previously unpaired devices want to start MMS ranging, they exchange initial data using Wi-Fi, Bluetooth or other PHY. Devices can measure Bluetooth, Wi-Fi or other-PHY-based CFO between them. Devices know the approximate CFO difference between their own Bluetooth/Wi-Fi/other-PHY and their own UWB clocks, e.g., from factory calibration. Devices then estimate UWB CFO, based on the measured Bluetooth/Wi-Fi/other-PHY CFO between the two devices and taking into account known offsets between their own Bluetooth/Wi-Fi and UWBs. CFO estimated this way can be treated as the center CFO with a set of CFO/timing slices placed around it.

Method 3: If there are several MMS exchanges, initial MMS exchange (if successful) can provide approximate CFO (but only as accurate as the step size of their CFO/timing slices). Subsequent MMS exchanges can use that value as the center CFO.

Method 4: In cases where MMS ranging is performed when the devices are sufficiently close to each other that the signal level is strong enough to allow for good CFO estimation using normal clock tracking loop, this CFO can be saved.

Method 5: Some devices have their Bluetooth (BT) PHY running off the same base clock (usually a crystal) as their UWB PHY, i.e, the clocks are coupled. This can be difficult to arrange in some devices, e.g., in mobile phones where BT is integrated on a different hardware subsystem but is generally easy to arrange in the design of a “Find me” tag like a Tile® device. Any device where the clocks are coupled can let other devices it communicates with know that it is coupled and can measure the CFO of both the BT transmissions it receives and the UWB transmissions it receives and can communicate those measurement results to the remote device it is talking to. The other device, even if it is not coupled, then has an accurate measurement of the offset between its two PHYs, and can communicate this knowledge when it sends the BT portion of its MMS exchange. It can also communicate how long it has been since the measurement to allow other devices to assess how much different it could be right now. If that delay is less than a few seconds, the offset will not have changed by more than 0.5 ppm, and probably much less than that. If it has been a few years, then the device knows that the current offset could be many ppm different, if the delay is of the order of milliseconds, then the frequency will hardly have changed at all. This information allows the MMS receiver to decide how many timing slices and carrier slices it needs to use to process the fragments. It can save power by deciding to implement fewer slices.

### Combining Multiple Fragments

After each fragment has been coherently accumulated, the separate accumulations are combined. Non-coherent combining methods (ignoring signal phase) are simple, but may have poorer performance. Fully coherent combining may perform better, but requires extremely precise CFO estimation, very stable clock signals and extremely low phase noise.

Various embodiments presented herein in this section can apply to implement step 420 in FIG. 4.

An implementation penalty of per-fragment processing is a number of accumulators needed (one per each carrier slice per each fragment). If there are 5 carrier slices and 8 fragments, there may be 40 fragment-accumulators to store. The memory 940 (or another memory) can be connected between blocks 910 and 920 to receive and temporarily store outputs from the bank of accumulators 910. Alternatively, the implementer may choose not to store fragment-accumulators, but instead, store a large number of final accumulators, which would be updated after each new fragment. These final accumulators may be stored in memory 940, with the memory 940 connected to the outputs of the bank of timing processing units 920. The implementation choice may depend on the number of fragments, the CFO range uncertainty, and the selected CFO step sizes (for both carrier and timing slices).

When combining fragments, timing drift also needs to be compensated for. While carrier slices can be spaced every 2 ppm, timings-slices need to be spaced more densely and that depends on the number of fragments (i.e., on the total time span from the first to the last fragment).

Timing drift is related to the CFO, however, when combining 8 fragments, the processing may preferably test timing drift in steps of 0.25 ppm (that is, 0.25 ns per millisecond). In the case of handling a +/−20 ppm CFO range, that means 161 possible final combined-accumulators.

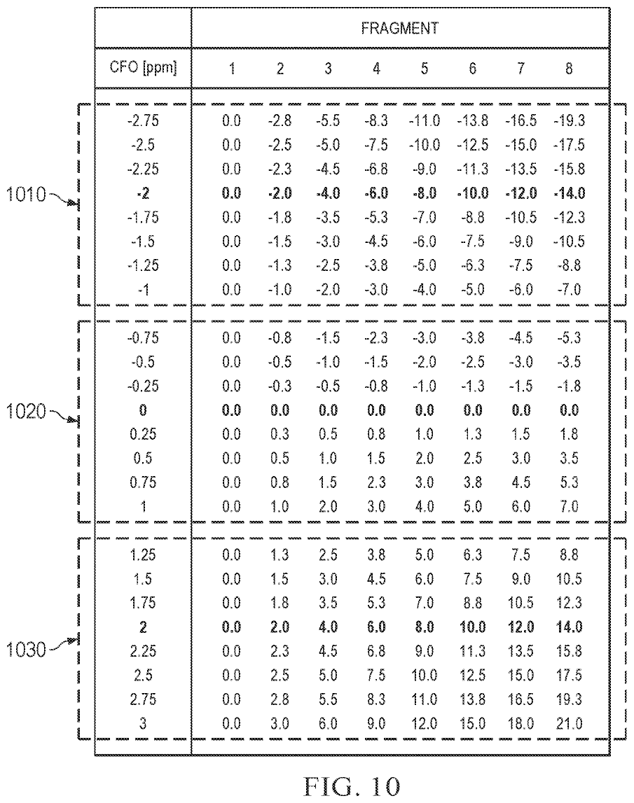

FIG. 10 illustrates example carrier slices (bold) and timing slices (non-bold), according to some aspects of the present disclosure. To calculate a number of final combined-accumulators for each timing slice (in 0.25 ppm steps), it is possible to use the stored fragment-accumulators from the nearest carrier slice (e.g., stored in memory 940 in device of FIG. 9). For example, 0 ppm carrier-slice fragment-accumulators can be used to calculate final combined-accumulator for all the timing slices in the −0.75 ppm to +1 ppm range (shown in the dashed box 1020). The slices half-way between the two nearest carrier slices can use either earlier or later carrier slice or the average between the two. Alternatively, any timing slice between the two carrier slices can use weighted average of the carrier slice accumulators, e.g., timing slice at 1 ppm uses two carrier slice accumulators: 50% of the 2 ppm carrier slices and 50% of the 0 ppm carrier slice. Other timing slices can use other weighting factors depending on the distance from the neighboring carrier slices. The dashed boxes 1010, 1020, and 1030 illustrate example carrier slices (bold) and timing slices corresponding to those carrier slices (timing slices corresponding to a carrier slice are grouped in dashed boxes). In this example, the carrier slices are at −2 ppm, 0 ppm, and +2 ppm. The first column represents the various CFO hypotheses tested, in this case from −2.75 ppm to 3 ppm in 0.25 ppm steps.

The timing slice processing involves using selected carrier slice accumulators for each fragment and adding them (coherently or non-coherently according to the algorithm selected) with timing drift compensation suitable for each fragment (that is, shifted by certain offset). The example timing offsets per fragment, for various CFOs are shown in the table above. For example, for CFO=1.5 ppm, subsequent fragments should be added with 1.5 ns, 3 ns, 4.5 ns, 6 ms, 7.5 ns, 9 ns, 10.5 ns offsets. Accumulators can be offset by a fractional number of ns either via interpolation (if needed, depending on the sample rate) or the offset can be rounded to the nearest available sample offset.

A receiver, such as a device 900 with the form as shown in FIG. 9, can process timing slices one after another, rejecting (not storing) the ones with lower peaks (to reduce the memory requirements) and only storing selected final-combined-accumulators with the largest peaks in the memory 940. A processor, such as processor 950, can be used to evaluate outputs of the MMS processing circuitry 930 to determine an estimate of the CFO offset and the timing.

A simple method of combining accumulator fragments is by a non-coherent method, where absolute values of all fragment accumulators are added (with timing drifts compensated). Such a method performs somewhat worse than perfect coherent combining (by about 1.6 dB for 8 fragments). However perfect coherent combining would require highly accurate CFO estimation, better than 5 parts-per-billion over 8 fragments) and very stable clocks, which may not be possible.

An alternative to non-coherent combining could be based on estimation of the phase change between fragments in order to compensate for it, thereby implementing non-perfect coherent combing (which may be referred to as “pseudo-coherent”). The phase change between fragments (which should be constant if the devices have stable clocks) can be estimated by the following methods.

Method 1: Use a good-quality, stronger reflected path (if one is present) as the phase reference.

Method 2: TWO-PASS approach, using non-coherent combining as PASS-1 and pseudo-coherent as PASS-2: Based on PASS-1, selecting N best candidate slices with the largest peaks (if the non-coherent peaks were deemed too low to accept any of them as the true 1^{st}-path). Then for each of the N candidate slices, extracting the sample which contributed to their largest peak (one sample from each fragment).
a) Estimating the phase changes of the extracted samples using linear regression of measured phase angles of each sample to get the best fit phase offset for each fragment. Unwrapping becomes a problem when the mean phase offset exceeds 90 degrees. In this case subtract an increasing angle from each sample, so subtract 0-degrees from sample extracted from fragment #1, subtract 180-degrees from sample extracted from fragment #2, subtract 360-degrees from sample extracted fragment #3 etc. up to (F−1)*180 degrees from the sample extracted from fragment F. Then again using linear regression on the corrected phase angles, then, if the combined peak is better than the normal linear regression, use it (but note here that it is necessary to add back the subtracted 180-degree phase multiples).
b) Testing all possible phase differences from 0 to 360 degrees in steps of X-degrees, combining samples (from all fragments) coherently and selecting the phase which produces the largest peak (or the peak exceeding the detection threshold).

Then, if any of the candidate peaks, after pseudo-coherent processing got accepted as the true path, processing all fragments for that candidate slice pseudo-coherently, using selected phase difference between fragments. Then searching for any weaker first paths.

Method 3: A single pass approach: for each carrier/timing slice testing for all possible phase differences, for example from 0 to 360 degrees in X-degrees steps and selecting the one which produces the largest peak. This approach can be very processing intensive as each fragment will be tested with 360/X different phases.

Method 1 above should provide very good performance and help identify weaker firstpaths, but a sufficiently strong reflection is not always available. Presence of stronger delayed reflections depends on the application and the channel. For example, in automotive scenarios, with a UWB keyfob in a back-pocket, the first path is frequently attenuated, but ground reflections tend to be much stronger; in those situations method 1 could be sufficient.

If a reflected path is so strong that it can be identified in all individual fragments, then selecting the correct carrier slice becomes straightforward (it will have the largest peaks) and selection of the timing slice can be done based on analysis of the strong path's drift between fragments. In that case only one carrier and timing slice need be processed and after coherent combining, existence of weaker, earlier paths may be established. To save the processing, the algorithm searching for the weaker earlier paths may need only to process the accumulator region before the previously identified path.

Method 2 will require two processing passes, in some embodiments. The first pass (could be for example non-coherent-based) is used to identify a number of candidate peaks in timing slices. Then in a second pass, the algorithm can process all timing slices, or only a selected N best timing slices (selected, for example, based on their largest peak magnitude).

In method 2(a), the algorithm can estimate the average phase change between fragments by analysing the phases of the samples contributing to candidate peaks. With a phase change estimate available, it is then possible to apply the phase compensation to the fragment accumulators and add them coherently.

In method 2(b), all possible phase changes between fragments are tested in small steps. The result is a number of coherently combined samples or accumulators for each hypothetical phase change between fragments. The result version with the largest peak can be then finally selected (if the peak satisfies certain criteria, for example peak amplitude above the threshold).

In method 2, there may be N candidate slices (and their peaks are being re-tested pseudo-coherently) but only one of the N candidate peaks is the true path. To reduce the processing, pseudo-coherent accumulation can be first performed only at the candidate peak's delay. If the peak fails the threshold criteria after pseudo-coherent processing, the whole slice can be rejected. If the peak is accepted, the pseudo-coherent processing can be applied to the whole candidate slice (processing pseudo-coherently all fragments) to search for earlier weaker paths. The thresholds applied (to accept a path or not) in the non-coherent first pass and in the pseudo-coherent second pass are different values.

In the basic version, the second pass re-tests pseudo coherently only one (the largest) peak from each timing slice. However, it is possible to re-test more, such as M largest non-coherent peaks from N candidate timing slices.

Method 3: Brute-force testing all possible phase changes between fragments across all timing slices.

Coherent methods are generally more processing-intensive and require more memory to store the complex samples.

With 8 fragments, perfect coherent accumulation improves the link-margin by 9.0 dBs, non-coherent by 7.4 dB and non-perfect-coherent (methods 2b or 2 c) by ~8.4 dB. In the case of method 1, the performance depends on the strength/quality of the delayed reflected path—if it is sufficiently strong, then the performance can be close to perfect coherent combining.

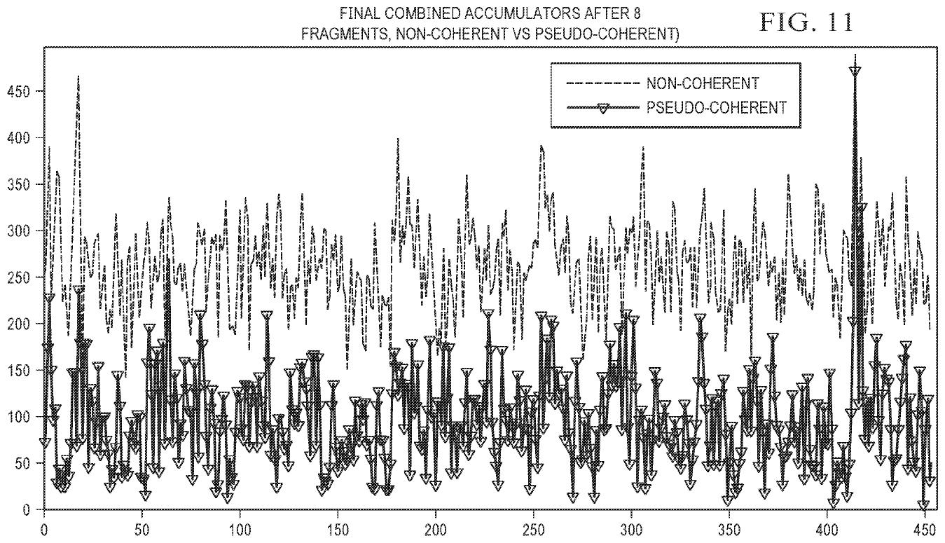

FIG. 11 presents an example of final combined accumulators, according to some aspects of the present disclosure. The non-coherent version typically has higher noise levels, as indicated in FIG. 11.

### Final Selection and the Peak Acceptance

Methods presented herein process fragments blindly without knowing an accurate CFO and typically without being able to identify the peak before the all the processing steps have been done.

However, even if there was a strong peak which could be identified early (for example already in the first fragment), the algorithm can continue processing fragments in order to obtain higher dynamic range and identify possible earlier but weaker paths.

Exemplary methods involve combining multiple fragments using multiple processing slices resulting in multiple candidate final accumulators. Typically, the slice with the highest peaks would be selected and accepted, provided that the peaks satisfy certain criteria, for example that their amplitude is higher than the required threshold. In some embodiments, the threshold depends on multiple factors, including combining methods and system architecture and should be chosen in a way to balance detection versus false alarm probabilities, as understood by those with ordinary skill in the art. The thresholds may also depend on the application and on the required security level. Secure applications will typically use much higher thresholds (and cryptographically generated pseudo random sequences).

Selection of the best slice also provides the receiver with the approximate CFO knowledge. Because carrier and timing slices are related to the true CFO. With this knowledge, subsequent MMS exchanges can use reduced CFO range (around the CFO estimated from previous MS exchanges), either to process fewer slices to save the processing power and/or to implement a denser slicing grid.

As discussed previously, fully coherent accumulation can require CFO estimation accuracy in the range of 5 ppb (parts-per-billion) for 8 fragments). If the achievable CFO accuracy is somewhat less accurate than that, for example 10-50 ppb, it is possible to use a modification of the device 900 and associated method. In that case, CFO estimate is accurate enough so that multiple carrier or timing slices are not required; however, the CFO estimate is not accurate enough to combine fragments coherently. The uncertainty concerns the phase change occurring between fragments. In that case a modification of the device 900 and associated method is required. Instead of processing multiple timing slices, the receiver processes multiple phase change hypotheses, resulting in multiple coherent final accumulators. Each final accumulator is produced for different hypothetical phase change between fragment accumulators. A number of hypotheses can be processed and stored temporarily, for example featuring a CFO step size of 10 ppb between hypotheses. The processing of fragments involves coherent addition of fragment accumulators with a gradually increasing phase drift compensation applied to consecutive fragments. This compensation corrects for erroneous phase drift due to CFO estimate not being perfect.

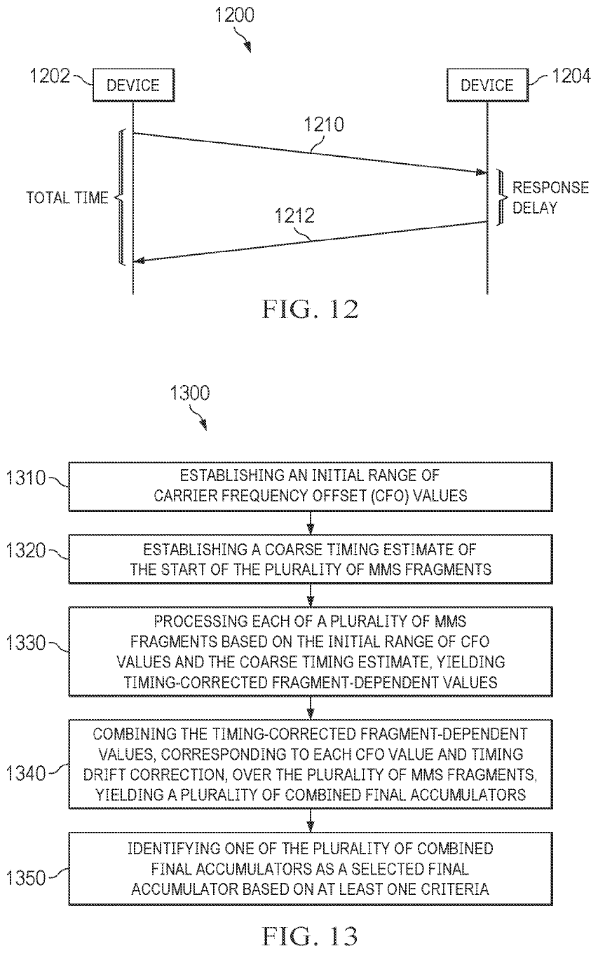

The techniques disclosed herein relate to ranging in UWB systems, particularly systems that use time of flight measurements between devices to determine location, sometimes also referred to as ranging. FIG. 12 is an example in which the techniques of the present disclosure, using MMS fragments, can be applied for determining location.

FIG. 12 is a diagram illustrating a two-way ranging-based localization system 1200 that uses UWB communications, according to aspects of the present disclosure. The system 1200 includes at least two devices capable of UWB communication using MMS fragments, such as device 1202 and device 1204. Device 1202 may initiate a ranging communication with a first communication, such as one or more messages, as shown, and Device 1204 may respond with one or more messages as shown. Two-way ranging is based determining distance using time-of-flight between two devices. The time of flight in this example is the total time between transmission and reception less some measure of response delay at device 1204. As understood by one of skill in the art, ranging techniques may also include additional communication, such as communication 1210.

Either of the devices 1202 or 1204 may include a cellular telephone, a smartphone, a laptop computer, a tablet, a personal digital assistant (PDA), a computing device, wearable devices (e.g., a smart watch, or the like), a device that can be attached to an object to use for location tracking or determination of the object, or any other mobile device having wireless connection capability.

FIGS. 2 and 3 illustrate transmissions that may occur in a UWB system, such as system 1200, for assisting in determining the location of a device, such as device 1202. In some embodiments, one or both of the devices 1202 or 1204 include the components illustrated in FIG. 9 and implement one or more of the techniques described herein. For example, in an embodiment, device 1202 may transmit UWB fragments as part of the communication 1210, and device 1204 estimates the associated timing using techniques associated with FIGS. 9 and 10. The timing may be used as part of ranging to determine the time of flight of messaging within 1210 and communicated to device 1202 via communication, such as 1212, to perform ranging. Communication 1212 may likewise include UWB fragments.

FIG. 13 illustrates an exemplary method of processing and combining MMS transmissions 1300, according to some aspects of the present disclosure. In step 1310, an initial range of CFO values is established. In step 1320, a coarse timing estimate of the start of the plurality of MMS fragments is established. For example, coarse CFO and timing start information may be derived from other PHYs, such as Bluetooth or WiFi, or from other techniques as disclosed herein. In step 1330, a plurality of MMS fragments is processed based on the initial range of CFO values and the coarse timing estimate, yielding timing-corrected fragment-accumulators. For example, a plurality of carrier slices and timing slices may be processed, as discussed with respect to FIG. 9. In step 1340, the timing-corrected fragment-accumulators, corresponding to each CFO value and timing drift correction, are combined over the plurality of MMS fragments (e.g., as the outputs of banks of timing processing units, such as 920), yielding a plurality of combined final accumulators. In step 1350, one of the plurality of combined final accumulators is identified as a selected final accumulator based on at least one criteria, such as using the largest peak, provided the peak exceeds a threshold. Ranging may be determined based on the selected final accumulator.

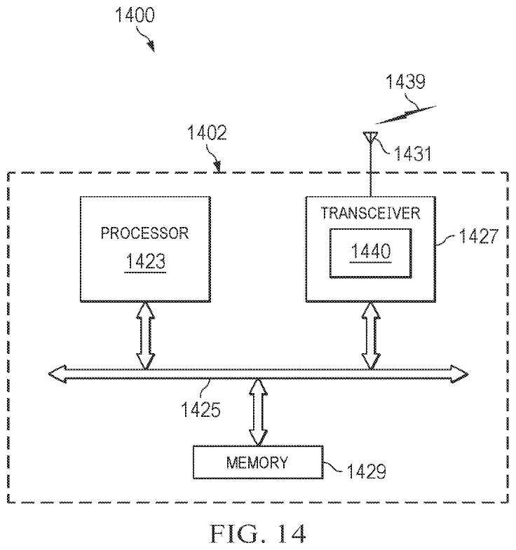

FIG. 14 illustrates an example of a communication device 1400, according to some aspects of the present disclosure. As shown, the device 1400 includes an antenna 1431, and a processor 1423, transceiver 1427, and a memory 1429 coupled via a bus or other type of connection. Transceiver 1427 may be operable to transmit and receive wireless signals 1439 via antenna 1431. Wireless signals 1439 may be transmitted/received via a wireless network. In some embodiments, the wireless network may be any wireless network such as a local wireless network, such as WiFi, a Personal Access Network (PAN), such as Matter, Bluetooth® or Zigbee®, or a cellular network (e.g., 4G, 5G). The transceiver 1427 may be implemented using at least one receiver and at least one transmitter, and may include a transmitter and a receiver for UWB communication and one or more transmitters and receivers for other types of communication, such as those listed above (WiFi, cellular, etc.).

Processor 1423 may include one or more general-purpose processors and/or one or more special-purpose processors, similar to processor 950. Memory 1429 may include one or more non-transitory storage devices, similar to memory 940. The transceiver 1427 may further include MMS processing circuitry 1440, such as the MMS processing circuitry 930 in FIG. 9.

Although only one antenna 1431 is shown in FIG. 14, the communication device 1400 may further include more than one antenna. For example, one antenna may be dedicated to UWB communications, and another antenna may be dedicated to wireless network transmissions for other wireless networks, such as WiFi, Bluetooth, or cellular.

Further aspects of the present disclosure include the following:

Aspect 1 includes a method of receiving a plurality of multi-millisecond (MMS) fragments in an ultra-wideband (UWB) device, the method comprising: establishing an initial range of carrier frequency offset (CFO) values; establishing a coarse timing estimate of a start of the plurality of MMS fragments; and processing each of the plurality of MMS fragments based on the initial range of CFO values and the coarse timing estimate, wherein for each MMS fragment, the processing comprises: performing coherent fragment accumulation using parallel processing for a plurality of carrier slice CFO values within the initial range, resulting in a number of fragment-accumulators; and applying parallel fragment-dependent timing drift correction to each corresponding fragment-accumulator, yielding a plurality of timing-corrected fragment-accumulators, one for each of a plurality of timing slice CFO hypotheses; after processing the plurality of MMS fragments, for each of the timing slice CFO hypotheses, combining the plurality of timing-corrected fragment-accumulators to yield a plurality of combined final accumulators; and identifying one of the plurality of combined final accumulators as a selected final accumulator based on at least one criteria.

Aspect 2 includes the method of aspect 1, wherein establishing the initial range of CFO values comprises: pairing the UWB device with another UWB device by way of transmitting or receiving UWB packets; estimating a coarse CFO estimate during the pairing; and establishing the initial range of CFO values based on the coarse CFO estimate and an error tolerance.

Aspect 3 includes the method of any of aspects 1 and 2, wherein the performing coherent fragment accumulation comprises: providing a signal to a first accumulator to generate a first fragment-accumulator; and providing the signal to a second accumulator to generate a second fragment-accumulator.

Aspect 4 includes the method of aspect 3, wherein the applying parallel fragment-dependent timing drift correction further comprises: providing the first fragment-accumulator to a first plurality of timing processing units to generate a first plurality of outputs; and providing the second fragment-accumulator to a second plurality of timing processing units to generate a second plurality of outputs.

Aspect 5 includes the method of any of aspects 1-4, wherein the identifying one of the plurality of final accumulators is based on which of the plurality of combined final accumulators has a largest magnitude.

Aspect 6 includes the method of aspect 5, wherein the largest magnitude is compared to a threshold.

Aspect 7 includes the method of any of aspects 1-6, wherein the combining the timing-corrected fragment-accumulators comprises summing absolute values of the fragment-accumulators.

Aspect 8 includes the method of any of aspects 1-6, wherein the combining the timing-corrected fragment-accumulators comprises coherently combining the timing-corrected fragment-accumulators.

Aspect 9 includes the method of any of aspects 1-6, wherein the combining the timing-corrected fragment-accumulators comprises estimating a phase change between fragments using a selected peak of fragment-accumulation signals and compensating for the phase change in combining the timing-corrected fragment-accumulators.

Aspect 10 includes the method of any of aspects 1-9, wherein establishing the initial range of CFO values comprises: receiving a message using a type of communication other than UWB communication; determining a coarse CFO estimate from the message; and establishing the initial range of CFO values based on the coarse CFO estimate and an error tolerance.

Aspect 11 includes the method of any of aspects 1-9, wherein establishing the initial range of CFO values comprises: exchanging messages with another device using a type of communication other than UWB communication, wherein a clock for the type of communication in the UWB device is coupled to a clock used for UWB communication, and wherein the initial range of CFO values is based on the messages.

Aspect 12 includes the method of any of aspects 1-11, wherein the selected final accumulator is used in a ranging application.

Aspect 13 includes the method of any of aspects 1-12, wherein a duration of each MMS fragment is less than 64 microseconds.

Aspect 14 includes a wireless apparatus comprising: a radio frequency circuit configured to downconvert a plurality of ultra-wideband (UWB) multi-millisecond (MMS) fragments to generate a plurality of received MMS fragments; a plurality of accumulators configured to process each of the plurality of received MMS fragments using a plurality of carrier slice CFO values, wherein the accumulators and carrier slice CFO values are in one-to-one correspondence, resulting in a number of fragment-accumulation signals per fragment; a plurality of banks of timing processing units, wherein each of the plurality of accumulators is coupled to a corresponding bank of timing processing units, and wherein, for each fragment, the plurality of banks of timing processing units apply parallel fragment-dependent timing offset correction to each corresponding fragment-accumulation signal, yielding timing-corrected fragment-accumulators, one for each of a plurality of timing slice CFO hypotheses; and a processor configured to: combine the timing-corrected fragment-accumulators for each of the plurality of timing slice CFO hypotheses over the plurality of MMS fragments to yield a plurality of combined final accumulators; and identify one of the plurality of combined final accumulators as a selected final accumulator based on at least one criteria.

Aspect 15 includes the wireless apparatus of aspect 14, wherein the plurality of carrier slice CFO values is within an initial range of CFO values established by pairing the wireless apparatus with another wireless UWB device.

Aspect 16 includes the wireless apparatus of any of aspects 14-15, wherein the identifying one of the plurality of final accumulators is based on which of the plurality of combined final accumulators has a largest magnitude.

Aspect 17 includes the wireless apparatus of any of aspects 14-16, wherein the combining the timing-corrected fragment-accumulators comprises summing absolute values of the fragment-accumulators.

Aspect 18 includes a wireless communication device comprising: a memory configured to store an initial range of carrier frequency offset (CFO) values and a coarse timing estimate of a start of a plurality of multi-millisecond (MMS) fragments; an ultra-wideband (UWB) receiver configured to receive the plurality of MMS fragments, wherein for each MMS fragment, the receiving comprises: performing coherent fragment accumulation using parallel processing for a plurality of carrier slice CFO values within the initial range, resulting in a number of fragment-accumulators; and applying parallel fragment-dependent timing drift correction to each corresponding fragment-accumulator, yielding a plurality of timing-corrected fragment-accumulators, one for each of a plurality of timing slice CFO hypotheses, and a processor configured to: after receiving the plurality of MMS fragments, for each of the plurality of timing slice CFO hypotheses, combine the timing-corrected fragment-accumulators yielding a plurality of combined final accumulators; and identify one of the plurality of combined final accumulators as a selected final accumulator based on at least one criteria.

Aspect 19 includes the wireless communication device of aspect 18, wherein the performing coherent fragment accumulation comprises: providing a signal to a first accumulator to generate a first fragment-accumulator; and providing the signal to a second accumulator to generate a second fragment-accumulator.

Aspect 20 includes the wireless communication device of any of aspects 19-20,wherein the applying parallel fragment-dependent timing drift correction further comprises: providing the first fragment-accumulator to a first plurality of timing processing units to generate a first plurality of outputs; and providing the second fragment-accumulator to a second plurality of timing processing units to generate a second plurality of outputs.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A method of receiving a plurality of multi-millisecond (MMS) fragments in an ultra-wideband (UWB) device, the method comprising:
establishing an initial range of carrier frequency offset (CFO) values;
establishing a coarse timing estimate of a start of the plurality of MMS fragments; and
processing each of the plurality of MMS fragments based on the initial range of CFO values and the coarse timing estimate, wherein for each MMS fragment, the processing comprises:
performing coherent fragment accumulation using parallel processing for a plurality of carrier slice CFO values within the initial range, resulting in a number of fragment-accumulators; and
applying parallel fragment-dependent timing drift correction to each corresponding fragment-accumulator, yielding a plurality of timing-corrected fragment-accumulators, one for each of a plurality of timing slice CFO hypotheses;
after processing the plurality of MMS fragments, for each of the timing slice CFO hypotheses, combining the plurality of timing-corrected fragment-accumulators to yield a plurality of combined final accumulators; and
identifying one of the plurality of combined final accumulators as a selected final accumulator based on at least one criteria.

2. The method of claim 1, wherein establishing the initial range of CFO values comprises:
pairing the UWB device with another UWB device by way of transmitting or receiving UWB packets;
estimating a coarse CFO estimate during the pairing; and
establishing the initial range of CFO values based on the coarse CFO estimate and an error tolerance.

3. The method of claim 1, wherein the performing coherent fragment accumulation comprises:
providing a signal to a first accumulator to generate a first fragment-accumulator; and
providing the signal to a second accumulator to generate a second fragment-accumulator.

4. The method of claim 3,
wherein the applying parallel fragment-dependent timing drift correction further comprises:
providing the first fragment-accumulator to a first plurality of timing processing units to generate a first plurality of outputs; and
providing the second fragment-accumulator to a second plurality of timing processing units to generate a second plurality of outputs.

5. The method of claim 1, wherein the identifying one of the plurality of final accumulators is based on which of the plurality of combined final accumulators has a largest magnitude.

6. The method of claim 5, wherein the largest magnitude is compared to a threshold.

7. The method of claim 1, wherein the combining the timing-corrected fragment-accumulators comprises summing absolute values of the fragment-accumulators.

8. The method of claim 1, wherein the combining the timing-corrected fragment-accumulators comprises coherently combining the timing-corrected fragment-accumulators.

9. The method of claim 1, wherein the combining the timing-corrected fragment-accumulators comprises estimating a phase change between fragments using a selected peak of fragment-accumulation signals and compensating for the phase change in combining the timing-corrected fragment-accumulators.

10. The method of claim 1, wherein establishing the initial range of CFO values comprises:
receiving a message using a type of communication other than UWB communication;
determining a coarse CFO estimate from the message; and
establishing the initial range of CFO values based on the coarse CFO estimate and an error tolerance.

11. The method of claim 1, wherein establishing the initial range of CFO values comprises:
exchanging messages with another device using a type of communication other than UWB communication, wherein a clock for the type of communication in the UWB device is coupled to a clock used for UWB communication, and wherein the initial range of CFO values is based on the messages.

12. The method of claim 1, wherein the selected final accumulator is used in a ranging application.

13. The method of claim 1, wherein a duration of each MMS fragment is less than 64 microseconds.

14. A wireless apparatus comprising:
a radio frequency circuit configured to downconvert a plurality of ultra-wideband (UWB) multi-millisecond (MMS) fragments to generate a plurality of received MMS fragments;
a plurality of accumulators configured to process each of the plurality of received MMS fragments using a plurality of carrier slice CFO values, wherein the accumulators and carrier slice CFO values are in one-to-one correspondence, resulting in a number of fragment-accumulation signals per fragment;
a plurality of banks of timing processing units, wherein each of the plurality of accumulators is coupled to a corresponding bank of timing processing units, and wherein, for each fragment, the plurality of banks of timing processing units apply parallel fragment-dependent timing offset correction to each corresponding fragment-accumulation signal, yielding timing-corrected fragment-accumulators, one for each of a plurality of timing slice CFO hypotheses; and
a processor configured to:
combine the timing-corrected fragment-accumulators for each of the plurality of timing slice CFO hypotheses over the plurality of MMS fragments to yield a plurality of combined final accumulators; and
identify one of the plurality of combined final accumulators as a selected final accumulator based on at least one criteria.

15. The wireless apparatus of claim 14, wherein the plurality of carrier slice CFO values is within an initial range of CFO values established by pairing the wireless apparatus with another wireless UWB device.

16. The wireless apparatus of claim 14, wherein the identifying one of the plurality of final accumulators is based on which of the plurality of combined final accumulators has a largest magnitude.

17. The wireless apparatus of claim 14, wherein the combining the timing-corrected fragment-accumulators comprises summing absolute values of the fragment-accumulators.

18. A wireless communication device comprising:
a memory configured to store an initial range of carrier frequency offset (CFO) values and a coarse timing estimate of a start of a plurality of multi-millisecond (MMS) fragments;
an ultra-wideband (UWB) receiver configured to receive the plurality of MMS fragments, wherein for each MMS fragment, the receiving comprises:
performing coherent fragment accumulation using parallel processing for a plurality of carrier slice CFO values within the initial range, resulting in a number of fragment-accumulators; and
applying parallel fragment-dependent timing drift correction to each corresponding fragment-accumulator, yielding a plurality of timing-corrected fragment-accumulators, one for each of a plurality of timing slice CFO hypotheses, and
a processor configured to:
after receiving the plurality of MMS fragments, for each of the plurality of timing slice CFO hypotheses, combine the timing-corrected fragment-accumulators yielding a plurality of combined final accumulators; and
identify one of the plurality of combined final accumulators as a selected final accumulator based on at least one criteria.

19. The wireless communication device of claim 18, wherein the performing coherent fragment accumulation comprises:
providing a signal to a first accumulator to generate a first fragment-accumulator; and
providing the signal to a second accumulator to generate a second fragment-accumulator.

20. The wireless communication device of claim 19, wherein the applying parallel fragment-dependent timing drift correction further comprises:
providing the first fragment-accumulator to a first plurality of timing processing units to generate a first plurality of outputs; and
providing the second fragment-accumulator to a second plurality of timing processing units to generate a second plurality of outputs.
